(19) United States
(12) Patent Application Publication
(10) Pub. No.: US 2018/0267389 A1
(43) Pub. Date: Sep. 20, 2018

(54) IMAGING DEVICE, TEMPERATURE ESTIMATION METHOD OF IMAGING DEVICE, AND NON-TRANSITORY STORAGE MEDIUM STORING TEMPERATURE ESTIMATION PROGRAM OF IMAGING DEVICE

(71) Applicant: Olympus Corporation, Tokyo (JP)

(72) Inventor: Takeru Kayano, Akiruno-shi (JP)

(21) Appl. No.: 15/917,469

(22) Filed: Mar. 9, 2018

(30) Foreign Application Priority Data
Mar. 14, 2017 (JP) 2017-049065

(51) Int. Cl. G03B 17/08; G03B 27/72

(52) U.S. Cl. CPC G03B 17/08; G03B 27/72

(57) ABSTRACT

An imaging device includes a plurality of operation modes. The imaging device includes a temperature sensor and an environmental temperature estimation unit. The temperature sensor is provided inside of the imaging device. The environmental temperature estimation unit estimates an outside environmental temperature of the imaging device based on an output of the temperature sensor and the operation modes.

### CROSS-REFERENCE TO RELATED APPLICATIONS

This application is based upon and claims the benefit of priority from the prior Japanese Patent Application No. 2017-049065, filed Mar. 14, 2017, the entire contents of which are incorporated herein by reference.

### BACKGROUND OF THE INVENTION

### 1. Field of the Invention

The present invention relates to an imaging device, a temperature estimation method of the imaging device, and a non-transitory storage medium storing a temperature estimation program of the imaging device.

### 2. Description of the Related Art

Recently, it is known that electronic devices, such as an imaging device for imaging an object and an observation device for observing a target like cells, include functions of measuring an outside temperature. For example, Jpn. Pat. Appln. KOKAI Publication No. 2000-310821 discloses the electronic camera apparatus, and the electronic camera is provided with the printer mechanism in which exposure conditions of sensitized papers for printing are changed, based on the outside temperature and the like measured by the outside temperature sensor so that printing can be carried out under optimal conditions suitable for the usage temperature environment. In Jpn. Pat. Appln. KOKAI Publication No. 2000-310821, the outside temperature sensor is configured to measure the outside temperature through the window provided in the main body of the electronic camera so that the outside temperature can be accurately measured.

### BRIEF SUMMARY OF THE INVENTION

According to a first aspect of the invention, there is provided an imaging device including a plurality of operation modes, the imaging device comprising: a temperature sensor that is provided inside of the imaging device; and an environmental temperature estimation unit that estimates an outside environmental temperature of the imaging device based on an output of the temperature sensor and the operation modes.

According to a second aspect of the invention, there is provided a temperature estimation method of an imaging device including a temperature sensor provided inside and a plurality of operation modes, the method comprising: obtaining an output of the temperature sensor; obtaining the operation modes; and estimating an outside environmental temperature of the imaging device based on the output of the temperature sensor and the operation modes.

According to a third aspect of the invention, there is provided a computer-readable non-transitory storage medium storing a temperature estimation program of an imaging device including a temperature sensor provided inside and a plurality of operation modes, the program comprising: obtaining an output of the temperature sensor; obtaining the operation modes; and estimating an outside environmental temperature of the imaging device based on the output of the temperature sensor and the operation modes.

Advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute apart of the specification, illustrate embodiments of the invention, and together with the general description given above and the detailed description of the embodiments given below, serve to explain the principles of the invention.

FIG. 1 is a block diagram illustrating a configuration of an imaging device according to a first embodiment.

FIG. 2 illustrates a configuration of a sensor unit.

FIG. 3 is a flowchart illustrating an operation of the imaging device according to the first embodiment.

FIG. 4 is a flowchart illustrating temperature and pressure measurement processing.

FIG. 5A illustrates time-dependent changes in outputs of a temperature sensor during a live view operation that is one of operation modes of the imaging device.

FIG. 5B illustrates time-dependent changes in outputs of the temperature sensor during 4K moving image capturing that is one of the operation modes of the imaging device.

FIG. 6A illustrates a comparison between the outside temperature and the output of the temperature sensor during the live view operation at an outside temperature of 40° C.

FIG. 6B illustrates a comparison between the outside temperature and the output of the temperature sensor during moving image capturing at an outside temperature of 40° C.

FIG. 7 illustrates an example of how coefficients a, b, and c are determined for each of the operation modes.

FIG. 8 illustrates a comparison of outputs of the temperature sensor before and after correction.

FIG. 9 schematically illustrates an outward appearance of an observation system as an example of an observation device according to a second embodiment.

FIG. 10 is a block diagram schematically illustrating an exemplary configuration of the observation system.

FIG. 11 is a flowchart illustrating observation device control processing as an operation of the observation device.

FIG. 12 is a flowchart illustrating observation and measurement processing.

### DETAILED DESCRIPTION OF THE INVENTION

Embodiments of the present invention will now be described with reference to the accompanying drawings.

### First Embodiment

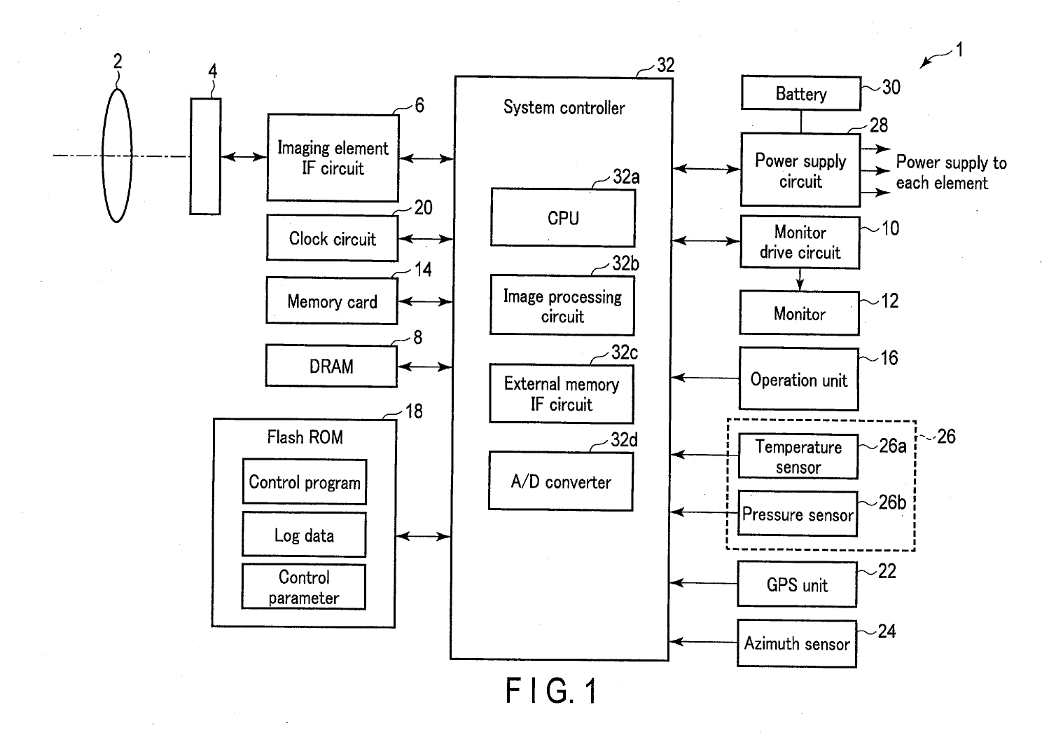

First, the first embodiment of the present invention will be described. FIG. 1 is a block diagram illustrating a configuration of an imaging device according to the first embodiment of the present invention. An imaging device 1 illustrated in FIG. 1 includes a lens 2, an imaging element 4, an imaging element interface (IF) circuit 6, a DRAM 8, a monitor drive circuit 10, a monitor 12, a memory card 14, an operation unit 16, a flash ROM 18, a clock circuit 20, a GPS unit 22, an azimuth sensor 24, a sensor unit 26, a power supply circuit 28, a battery 30, and a system controller 32. The imaging device 1 is various kinds of electronic devices having imaging functions such as a digital camera and a smartphone. It may be assumed that the imaging device 1 is used in water. Thus, the casing, etc. of the imaging device 1 may be waterproof.

The lens 2 is an optical system for forming an image of a light beam from an object (not shown) on the imaging element 4. The lens 2 may include a focusing lens or may include a zoom lens. The lens 2 may also include a diaphragm capable of adjusting an aperture amount.

The imaging element 4 is arranged on the optical axis of the lens 2 and where an image of light beam from the object is formed by the lens 2. The imaging element 4 includes pixels arranged two-dimensionally or three-dimensionally. Each pixel generates an electric charge in accordance with an amount of light received. Each pixel is provided with a color filter. The imaging element 4 as described above images an object and generates an image signal. The imaging element 4 may include focus detection pixels. The imaging element 4 maybe configured to capture full high definition (HD) moving images (2K moving images) and high resolution 4K moving images (4K30p moving images).

The imaging element IF circuit 6 causes the imaging element 4 to execute an imaging operation under the control of the CPU 32a in the system controller 32. The imaging element IF circuit 6 reads the image signal obtained by the imaging element 4 under the control of the CPU 32a, and subjects the read image signal to analog processing such as correlated double sampling (CDS) processing and automatic gain control (AGC) processing. The imaging element IF circuit 6 converts the analog-processed image signal into a digital signal (hereinafter referred to as image data).

The DRAM 8 temporarily stores various data such as image data obtained in the imaging element IF circuit 6 and data used in various kinds of processing in the system controller 32. Furthermore, the DRAM 8 temporarily stores data obtained using sensors such as a GPS unit 22, an azimuth sensor 24, and a sensor unit 26. An SDRAM may be used instead of the DRAM.

The monitor drive circuit 10 displays an image on the monitor 12 based on the image data input from the CPU 32a of the system controller 32.

The monitor 12 is a display unit such as a liquid crystal display (LCD) or an organic EL display, for example. The monitor 12 is driven by the monitor drive circuit 10, and displays various images such as an image for a live view and an image recorded in the memory card 14.

The memory card 14 is an external memory attached to the casing of the imaging device 1. An image file obtained by photography is recorded in the memory card 14. The image file is formed by attaching a predetermined header to image data.

The operation unit 16 includes operation members such as a power switch (SW) for switching the imaging device 1 on and off, a release switch (SW) for issuing an instruction for image capturing, a moving image capturing switch (SW) for starting and ending moving image capturing, and a menu button for displaying menu items for changing and setting various setting values and operation modes of the imaging device 1. The operation unit 16 may include a touch panel that functions in a manner similar to the operation members. The operation unit 16 detects operation conditions of various operation members, and outputs to the system controller 32 a signal indicating a detection result.

The flash ROM 18 stores a control program for causing the CPU 32a to execute various kinds of processing. The flash ROM 18 stores data obtained by using sensors such as the GPS unit 22, the azimuth sensor 24, and the sensor unit 26, as log data. In the log data, data items obtained by using sensors such as the GPS unit 22, the azimuth sensor 24, and the sensor unit 26 are associated with acquisition times of the respective data items. The flash ROM 18 stores various control parameters such as a control parameter necessary to operate the lens 2, the imaging element 4, and the like, and a control parameter necessary for image processing in the image processing circuit 32b. In the present embodiment, the flash ROM 18 stores a correction formula, as a control parameter, to estimate an outside temperature from the output of the temperature sensor 26a of the sensor unit 26. This correction formula is stored for every mode of the imaging device 1.

The clock circuit 20 measures various times such as current time. The data obtained by using sensors such as the GPS unit 22, the azimuth sensor 24, and the sensor unit 26 is associated with the time measured by the clock circuit 20.

The GPS unit 22 includes a GPS receiver that receives radio waves from a satellite, a base station, and the like, and acquires information to generate data on a current location of the imaging device 1. The azimuth sensor 24 acquires information to generate data on an azimuth of the imaging device 1.

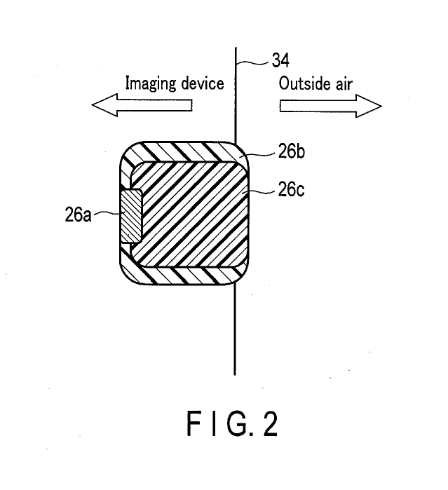

The sensor unit 26 is a sensor formed by a combination of the temperature sensor 26a and the pressure sensor 26b. The temperature sensor 26a is a sensor for detecting a temperature at the vicinity of the casing of the imaging device 1. The pressure sensor 26b is a sensor for detecting a pressure (air pressure, water pressure, and the like) from the outside of the imaging device 1. FIG. 2 shows a configuration of the sensor unit 26. As shown in FIG. 2, the pressure sensor 26b has an approximately C-shaped cross section, and is arranged in the neighborhood of the outer periphery of the casing 34 of the imaging device 1 in such a manner that part of the pressure sensor 26b comes into contact with the outside air. The temperature sensor 26a is arranged in the neighborhood of the pressure sensor 26b and inside the casing 34 of the imaging device 1 so as not to come into contact with the outside air. Although not shown, a pressure detection unit of the pressure sensor 26b is arranged in the neighborhood of the temperature sensor 26a. In the example of FIG. 2, the temperature sensor 26a is arranged in a concave portion of the approximately C-shaped pressure sensor 26b. A gel 26c is filled in the pressure sensor 26b in such a manner as to cover the temperature sensor 26a. With the gel 26c, the temperature sensor 26a does not come into contact with the outside air while being in the neighborhood of the pressure sensor, 26b. Moreover, with the gel 26c, the temperature sensor 26a is watertight. The temperature sensor 26a is also used for correcting temperature characteristics of the pressure sensor 26b.

The power supply circuit 28 converts power supplied from the battery 30 to power having the magnitude required by each element of the imaging device 1 to supply it to each element of the imaging device 1. The battery 30 is, for example, a secondary battery provided in the casing of the imaging device 1.

The system controller 32 is a control circuit for controlling operations of the imaging device 1. The system controller 32 includes the CPU 32a, the image processing circuit 32b, an external memory IF circuit 32c, and an A/D converter 32d.

The CPU 32a is a control unit for controlling operations of blocks outside of the system controller 32 such as the imaging element IF circuit 6 and the monitor drive circuit 10, and operations of the imaging processing circuit 32b and the like inside the system controller 32. The CPU 32a also functions as an environmental temperature estimation unit, and estimates the outside temperature as the environmental temperature outside of the imaging device 1 based on the output of the temperature sensor 26a and the operation mode of the imaging device 1. The CPU 32a does not necessarily have to be a CPU, and may be made of an ASIC, an FPGA, and the like.

The image processing circuit 32b applies various kinds of image processing to image data. Examples of the image processing include color correction processing, gamma correction processing, and compression processing. The image processing circuit 32b applies decompression processing to the compressed image data.

The external memory IF circuit 32c is an interface circuit for communicating various data items between the memory card 14 and the flash ROM 18, etc., by the system controller 32.

The A/D converter 32d converts detection signals, output as analog signals from the GPS unit 22, the azimuth sensor 24, the temperature sensor 26a and the pressure sensor 26b of the sensor unit 26, into digital signals to supply the signals into the system controller 32.

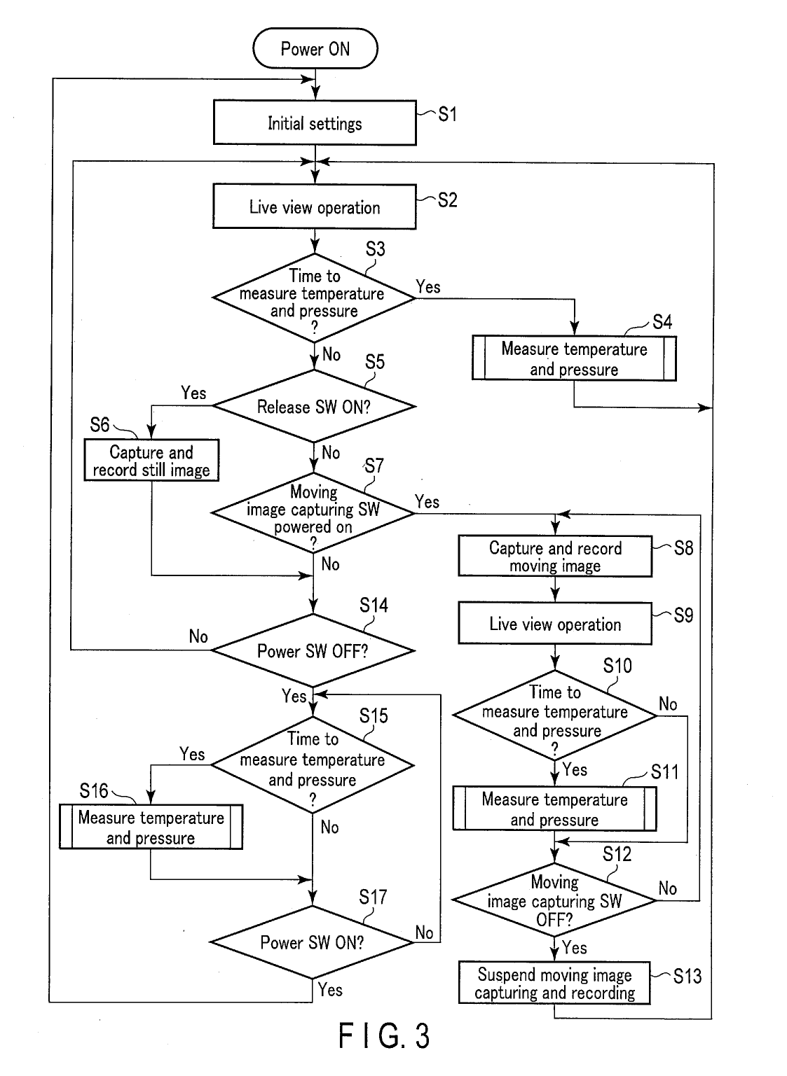

Next, a description will now be given of an operation of the imaging device according to the present embodiment. FIG. 3 is a flowchart illustrating an operation of the imaging device 1. The CPU 32a reads a necessary control program from the flash ROM 18 to control the operation shown in FIG. 3. Although FIG. 3 does not show processing of a reproduction mode for reproducing the image file, the imaging device 1 may include a reproduction mode.

In step S1, the CPU 32 performs initial settings for the imaging device 1. For example, the CPU 32a prepares to activate the imaging element 4, the monitor 12, and the like, and initializes resistors for various kinds of processing. After the initial settings are completed, the processing advances to step S2.

In step S2, the CPU 32a starts a live view operation. As the live view operation, the CPU 32a controls the imaging element IF circuit 6 to start imaging at the predetermined frame rate for the live view operation by the imaging element 4. Thereafter, the CPU 32a inputs the image data stored in the DRAM 8 as a result of imaging by the imaging element 4 into the image processing circuit 32b to apply live view display image processing. Next, the CPU 32a inputs image data, to which the live view display image processing has been applied, into the monitor drive circuit 10 to display the image on the monitor 12. The CPU 32a repeatedly performs the above-described imaging operation and display operation. By the live view operation as described above, a user can observe the object through the monitor 12.

In step S3, the CPU 32a determines whether a timing to measure a temperature and a pressure has come. For example, every time a predetermined interval (5 minutes) elapses, it is determined that the timing to measure the temperature and the pressure has come. If it is determined in step S3 that the timing to measure the temperature and the pressure has come, the processing advances to step S4. If it is determined in step S3 that the timing to measure the temperature and the pressure has not come, the processing advances to step S5.

In step S4, the CPU 32a executes temperature and pressure measurement processing. After the temperature and pressure measurement processing is completed, the processing returns to step S2. Details of the temperature and pressure measurement processing will be explained later.

In step S5, the CPU 32a determines whether the release switch is turned on by the user's operation. If it is determined in step S5 that the release switch is turned on, the processing advances to step S6. If it is determined in step S5 that the release switch is not turned on, the processing advances to step S7.

In step S6, the CPU 32a executes still image photography and stores image data obtained by the still image photography in the memory card 14. As the still image photography operation, the CPU 32a controls the imaging element IF circuit 6 to start to take images for still image recording by the imaging element 4. Thereafter, the CPU 32a inputs the image data, stored in the DRAM 8 as a result of imaging by the imaging element 4, into the image processing circuit 32b to apply image processing for still image recording. Next, the CPU 32a adds predetermined header information to image data for recording to generate a still image file. In the header information, besides data on an image capturing time and image capturing conditions, data on a current location of the imaging device 1, a current azimuth of the imaging device 1, and a current outside temperature and pressure are recorded. The CPU 32a stores the generated still image file in the memory card 14 through the external memory IF circuit 32c. After this processing, the processing advances to step S14.

In step S7, the CPU 32a determines whether the moving image capturing switch is turned on by the user's operation. If it is determined in step S7 that the moving image capturing switch is turned on, the processing advances to step S8. If it is determined in step S7 that the moving image capturing switch is not turned on, the processing advances to step S14.

In step S8, the CPU 32a executes moving image capturing, and stores image data obtained by moving image capturing in the memory card 14. As a moving image capturing operation, the CPU 32a controls the imaging element IF circuit 6 to start to take images at the predetermined frame rate for moving image recording by the imaging element 4. The image data obtained as a result of imaging by the imaging element 4 is stored in the DRAM 8.

In step S9, the CPU 32a carries out a live view operation. The live view operation is basically similar to the operation explained for step S2. Imaging for the live view operation in step S9 may be replaced with imaging for moving image recording in step S8.

In step S10, the CPU 32a determines whether a timing to measure the temperature and the pressure has come. For example, like step S3, every time a predetermined interval (5 minutes) elapses, it is determined that the timing to measure the temperature and the pressure has come. If it is determined in step S10 that the timing to measure the temperature and the pressure has come, the processing advances to step S11. If it is determined in step S10 that the timing to measure the temperature and the pressure has not come, the processing advances to step S12.

In step S11, the CPU 32a executes temperature and pressure measurement processing similar to that in step S4. After the temperature and pressure measurement processing is completed, the processing advances to step S12. Details of the temperature and pressure measurement processing will be explained later.

In step S12, the CPU 32a determines whether a moving image capturing switch is turned off by the user's operation. If it is determined in step S12 that the moving image capturing switch is turned off, the processing advances to step S13. If it is determined in step S12 that the moving image capturing switch is not turned off, the processing returns to step S8. In this case, moving image capturing continues.

In step S13, the CPU 32a carries out a processing of suspending moving image capturing and recording. As the processing of suspending moving image capturing and recording, the CPU 32a inputs image data (moving image frame) stored in the DRAM 8 by a series of moving image capturing into the image processing circuit 32b to apply image processing for moving image recording. Next, the CPU 32a generates a moving image file based on the moving image frame for recording. In the moving image file, besides data on image capturing time and image capturing conditions, data on a current location of the imaging device 1, a current azimuth of the imaging device 1, and an outside temperature and pressure are recorded in association with the acquisition time thereof. The CPU 32a stores the generated moving image file in the memory card 14 through the external memory IF circuit 32c. After this processing, the processing returns to step S2.

In step S14, the CPU 32a determines whether the power supply switch is turned off by the user's operation. If it is determined in step S14 that the power supply switch is turned off, the processing advances to step S15. The power supply circuit 28 turns off the imaging element 4 and its relevant circuits, the monitor 12 and its relevant circuits, and the image processing circuit 32b and the memory IF circuit 32c of the system controller 32, and then a power saving mode begins. If it is determined in step S14 that the power supply switch is not turned off, the processing returns to step S2. In this case, the live view operation continues.

In step S15, the CPU 32a determines whether a timing to measure the temperature and the pressure has come. For example, like step S3, every time a predetermined interval (5 minutes) elapses, it is determined that the timing to measure the temperature and the pressure has come. If it is determined in step S15 that the timing to measure the temperature and the pressure has come, the processing advances to step S16. If it is determined in step S15 that the timing to measure the temperature and the pressure has not come, the processing advances to step S17.

In step S16, the CPU 32a executes temperature and pressure measurement processing similar to that in step S4. After the temperature and pressure measurement processing is completed, the processing advances to step S17. Details of the temperature and pressure measurement processing will be explained later.

In step S17, the CPU 32a determines whether the power supply switch is turned on by the user's operation. If it is determined in step S17 that the power supply switch is turned on, the processing returns to step S1. If it is determined in step S17 that the power supply switch is not turned on, the processing returns to step S15. That is, in the present embodiment, even if the imaging device 1 is powered off, the temperature and pressure measurement processing is executed when the timing comes to measure the temperature and the pressure.

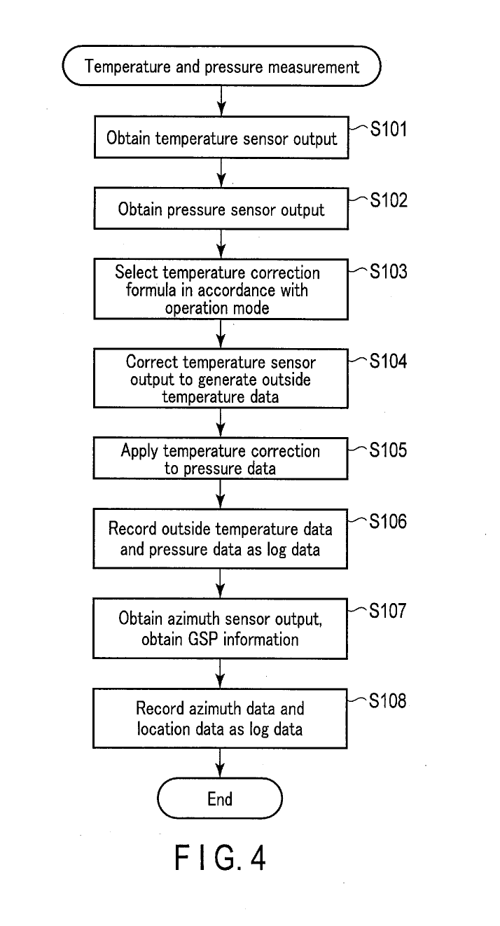

FIG. 4 is a flowchart showing the temperature and pressure measurement processing. In step S101, the CPU 32a obtains the output of the temperature sensor 26a via the A/D converter 32d. In step S102, the CPU 32a obtains the output of the pressure sensor 26b via the A/D converter 32d.

In step S103, the CPU 32a selects a temperature correction formula to correct the output of the temperature sensor 26a in accordance with the current operation mode. Hereinafter, a description will be given of selection of the temperature correction formula.

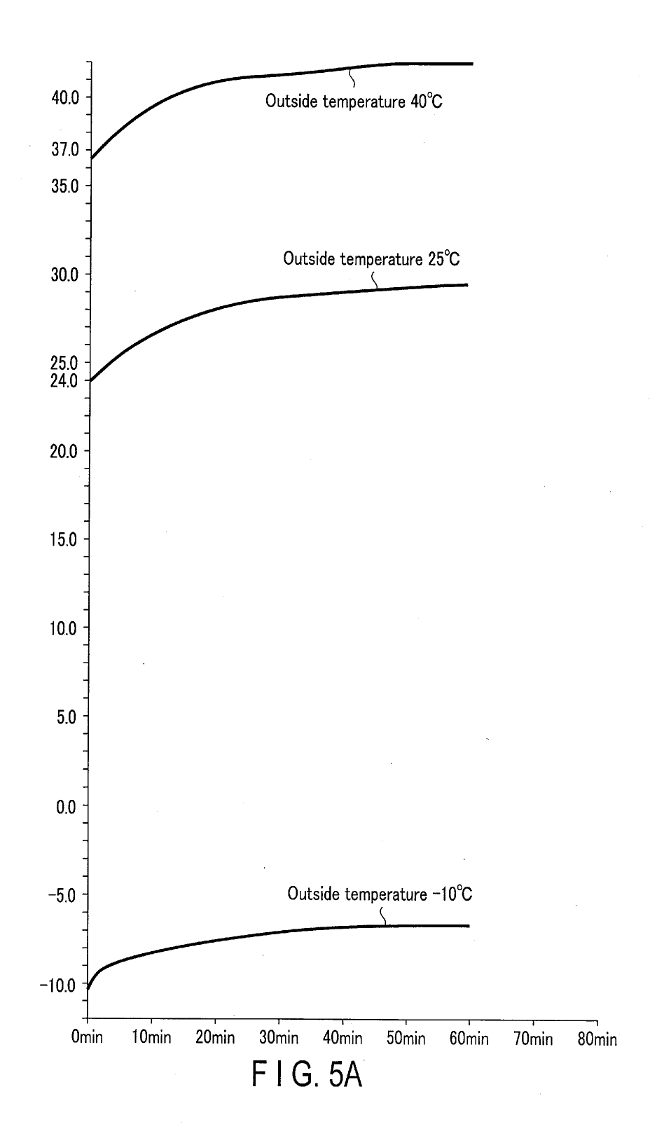

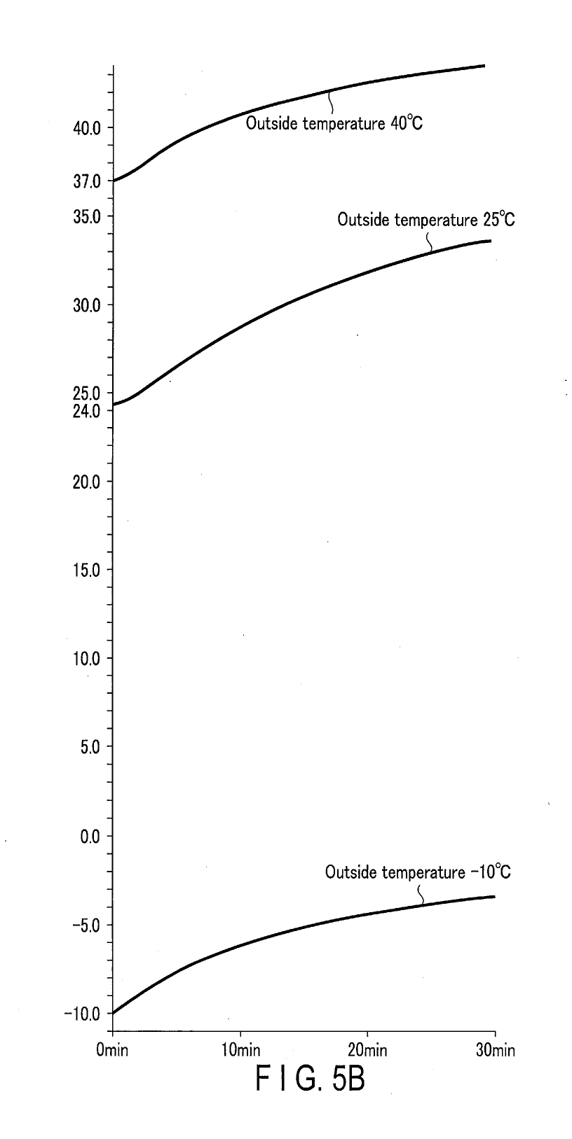

FIG. 5A and FIG. 5B illustrate time-dependent changes in outputs of the temperature sensor 26a in accordance with the outside temperature as the environmental temperature of the imaging device 1. FIG. 5A illustrates time-dependent changes in outputs of the temperature sensor 26a during a live view operation that is one of operation modes of the imaging device 1. FIG. 5B illustrates time-dependent changes in outputs of the temperature sensor 26a during 4K moving image capturing that is one of the operation modes of the imaging device 1. In FIG. 5A and FIG. 5B, the abscissa axis represents the time elapsed from the start of the operation of each operation mode. In FIG. 5A and FIG. 5B, the ordinate axis represents the outputs of the temperature sensor 26a in each operation mode. FIG. 5A and FIG. 5B exemplify three outputs, i.e., the output of the temperature sensor 26a when the outside temperature is −10° C., the output of the temperature sensor 26a when the outside temperature is 25° C., and the output of the temperature sensor 26a when the outside temperature is 40° C.

As described above, during the live view operation, the imaging element 4 repeatedly performs imaging. By repeatedly performing imaging, the imaging element 4 and the like generate heat. The temperature sensor 26a as shown in FIG. 2 is arranged in the casing of the imaging device 1, and is thus affected by the generated heat of the imaging element 4 and the like. As shown in FIG. 5A, the temperature indicated by the temperature sensor 26a is substantially the same value as the outside temperature at the beginning of the live view operation, and then becomes higher as the time elapses. As shown in FIG. 5A, the rate of increase of the output of the temperature sensor 26a becomes higher as the outside temperature is higher.

Similarly, in moving image capturing, the imaging element 4 repeatedly performs imaging. By repeatedly performing imaging, the imaging element 4 generates heat. For the amount of heat generated during moving image capturing, the power consumed by the imaging element 4 and circuits such as the imaging processing circuit 32b is greater. Thus, it is higher than the amount of heat generated during the live view operation. Thus, the rate of increase of the output of the temperature sensor 26a during moving image capturing is higher than that during live view operation as shown in FIG. 5B.

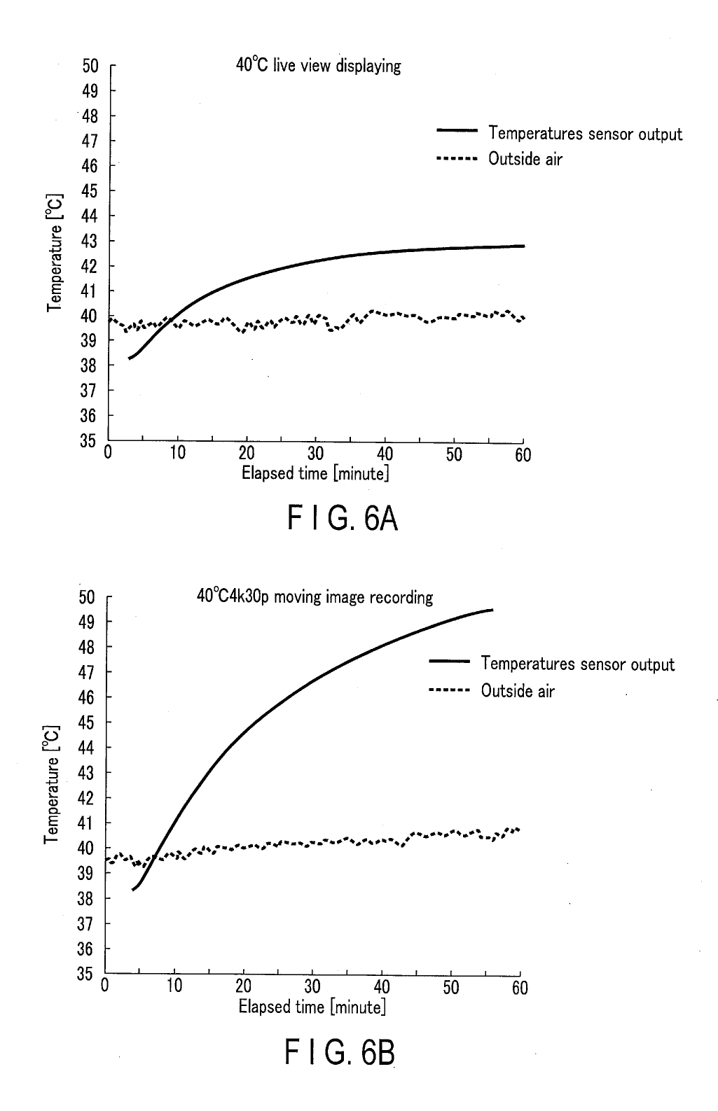

FIG. 6A illustrates a comparison between the outside temperature and the output of the temperature sensor 26a during the live view operation at an outside temperature of 40° C. As shown in FIG. 5A, even when the outside temperature is 40° C., during the live view operation, the output of the temperature sensor 26a increases as the time elapses. However, for the similar imaging device, characteristics of the output of the temperature sensor 26a with respect to the elapsed time are the characteristics shown in FIG. 5A. As shown in FIG. 6A, for example, the temperature indicated by the output of the temperature sensor 26a when 55 minutes has elapsed from the start of the live view operation is approximately 3° C. higher than the outside temperature every time.

FIG. 6B illustrates a comparison between the outside temperature and the output of the temperature sensor 26a during moving image capturing at an outside temperature of 40° C. In case of FIG. 6B, for example, the temperature indicated by the output of the temperature sensor 26a when 55 minutes has elapsed after the start of moving image capturing is approximately 10° C. higher than the outside temperature every time.

Thus, in the similar imaging device, substantially similar circuits operate in the substantially similar manner for every operation mode, and characteristics of the output of the temperature sensor 26a with respect to the elapsed time for every operation mode are uniform. Thus, it is possible to estimate the outside temperature based on the increase amount of the output of the temperature sensor 26a with respect to the elapsed time for every operation mode and the output of the temperature sensor 26a arranged inside the casing of the imaging device 1. The concrete correction formula of the output of the temperature sensor 26a is represented by (Formula 1) below:

Te=Ts+a−(b×t^{c}) (Formula 1)
where Te is an outside temperature, Ts is an output of the temperature sensor, t is elapsed time from the operation start in the current operation mode, and a, b, and c are coefficients.

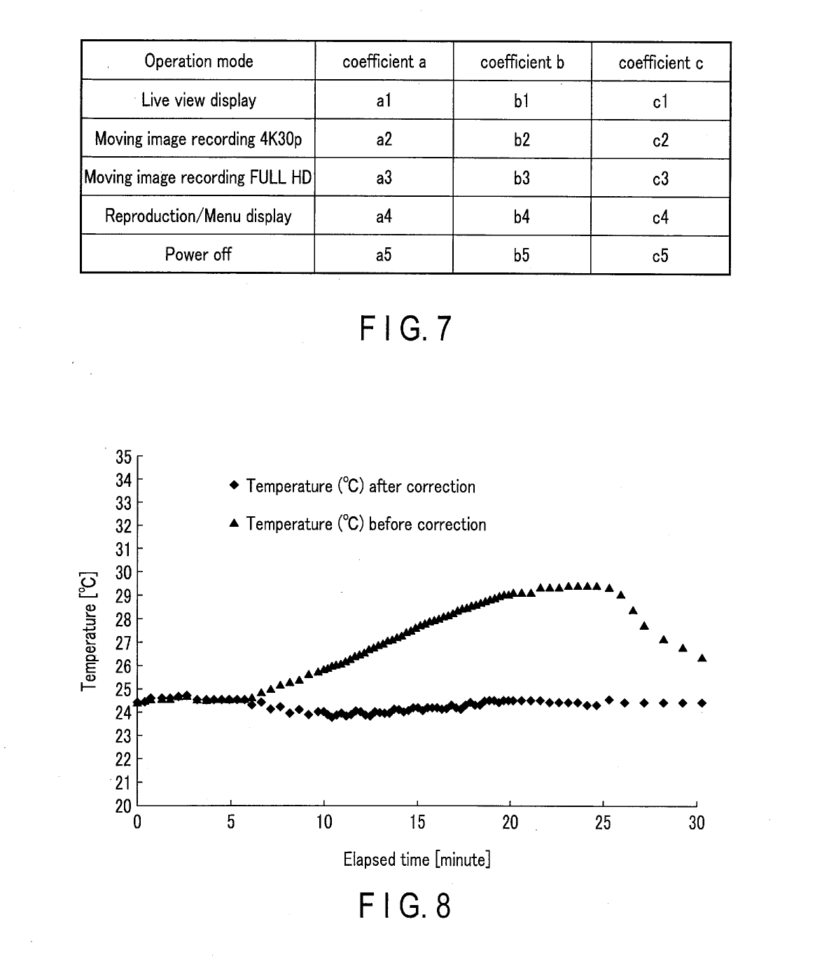

Coefficients a, b, and c in (Formula 1) differ in accordance with operation modes. Thus, if coefficients a, b, and c for each operation mode are stored in the flash ROM 18, for example, even when the operation mode changes, it is possible to estimate the outside temperature from the output of the temperature sensor 26a. FIG. 7 illustrates an example of how coefficients a, b, and c are determined for each operation mode. FIG. 7 shows operation modes of a live view display, high resolution 4K (4K30p) moving image recording, full HD moving image recording (2K moving image recording), reproduction or menu display, and power off, and coefficients a, b, and c are set for the respective operation modes. In step S103, the CPU 32a selects respective coefficients a, b, and c shown in FIG. 7 in accordance with the current operation mode to select a temperature correction formula. For example, in the temperature and pressure measurement processing in step S4, the CPU 32a selects a1 as coefficient a, selects b1 as coefficient b, and selects c1 as coefficient c. After the temperature correction formula is selected, the processing advances to step S104.

In step S104, the CPU 32a corrects, based on the selected temperature correction formula, the output of the temperature sensor 26a obtained in step S101 to generate outside temperature data. FIG. 8 illustrates a comparison of outputs of the temperature sensor before and after correction. In FIG. 8, the abscissa axis is an elapsed time. In the example of FIG. 8, the outside air temperature is 25° C. In the example of FIG. 8, the imaging device 1 is turned off at an elapsed time of 0 minutes, the imaging device 1 is turned on at an elapsed time of 5 minutes, the live view operation is carried at an elapsed time of 5 to 10 minutes, 4K moving image capturing is carried out at an elapsed time of 10 to 20 minutes, the live view operation is carried out once again at an elapsed time of 20 to 25 minutes, and the imaging device 1 is turned off at an elapsed time of 25 minutes. As shown in FIG. 8, the output of the temperature sensor 26a before correction varies with the changes in the operation modes and the elapsed time, but the output of the temperature sensor 26a after correction remains at approximately 25° C.

The temperature correction formula does not necessarily have to be one indicated by (Formula 1). As the temperature correction formula, an approximation formula different from (Formula 1) maybe used. Furthermore, in step S104, calculation of outside temperature data is carried out based on the temperature correction formula. Calculation of outside temperature data may be carried out from the table in which the output before correction and the output after correction of the temperature sensor 26a are associated with each other for each operation mode and each elapsed time.

In step S105, the CPU 32a corrects, based on the outside temperature data, the output of the pressure sensor 26b obtained in step S102 to generate pressure data.

In step S106, the CPU 32a stores the outside temperature data and the pressure data associated with the current time as log data in the flash ROM 18.

In step S107, the CPU 32a obtains an output of the GPS unit 22 and an output of the azimuth sensor 24.

In step S108, the CPU 32a stores in the flash ROM 18, as log data, data on the current location of the imaging device 1 generated based on the output of the GPS unit 22, and data on the current azimuth of the imaging device 1 generated based on the output of the azimuth sensor 24, in association with the current time. Then, the processing in FIG. 4 is brought to an end.

According to the embodiment described above, the imaging device utilizes the feature that the characteristics of the output of the temperature sensor 26a with respect to the elapsed time are even for each operation mode, and it is thus possible to estimate the outside temperature of the environmental temperature outside of the imaging device 1 from the output of the temperature sensor 26a inside the casing of the imaging device 1.

### Second Embodiment

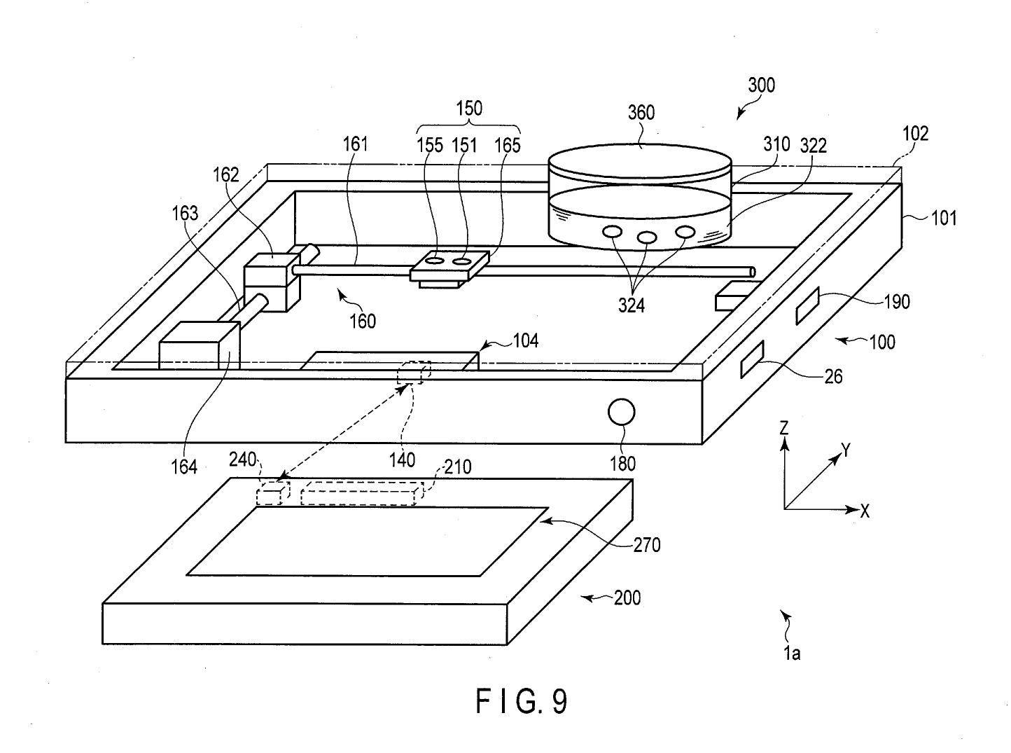

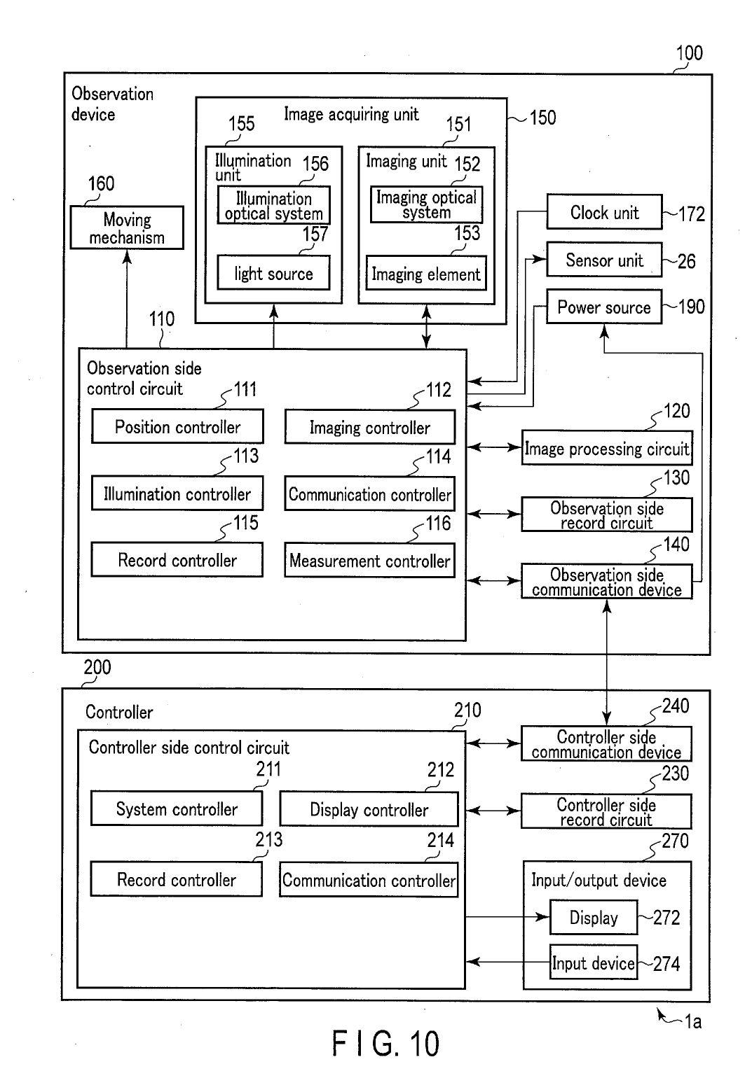

A description will now be given of the second embodiment of the present invention. In the second embodiment, an observation device for observing a target object such as cells estimates the outside temperature in a manner similar to that of the first embodiment. FIG. 9 schematically illustrates an outward appearance of an observation system 1a as an example of an observation device according to the second embodiment of the present invention. FIG. 10 is a block diagram schematically illustrating an exemplary configuration of the observation system 1a.

The observation system 1a of the present embodiment is a system which takes images of a cell, a cell group, and a tissue which are being cultured, and which makes a record of the numbers of cells or cell groups and the shapes thereof. The observation system 1a comprises an observation device 100 and a controller 200. The observation device 100 is approximately plate shaped. A sample 300 to be observed is arranged on top of the observation device 100. The observation device 100 and the sample 300 are provided, for example, inside an incubator. For the sake of explanation, an x-axis and a y-axis perpendicular to each other are defined in a plane parallel to the surface of the observation device 100 on which the sample 300 is arranged, and a z-axis is defined as an axis perpendicular to both the x-axis and the y-axis.

The observation device 100 includes a casing 101, a transparent plate 102, and an image acquiring unit 150. The transparent plate 102 is arranged on top of the casing 101. The image acquiring unit 150 is provided inside the casing 101, and illuminates and takes an image of the sample 300 through the transparent plate 102 to acquire an image of the sample 300. On the other hand, the controller 200 is provided on the outside of the incubator, for example. The observation apparatus 100 and the controller 200 communicate with each other. The controller 200 transmits various instructions to the observation device 100 and acquires and analyzes data obtained from the observation device 100.

The observation system 1a can take an image of a wide range of the sample 300 by, in a one-time observation operation, repeatedly taking an image while the image acquiring unit 150 moves in the X axis direction and the Y axis direction. The observation system 1a repeatedly performs such observation operation with an interval in accordance with the predetermined sequence.

An example of the sample 300 to be measured by the observation system 1a will be described. The sample 300 includes, for example, a vessel 310, a culture medium 322, cells 324, and a reflecting plate 360. The culture medium 322 is in the vessel 310, and cells 324 are cultured in the culture medium 322. The vessel 310 is, for example, a petri dish, a culture flask, a multi-well plate, or the like. The vessel 310 is a culture vessel for culturing a living specimen, for example. The vessel 310 is not limited to any specific shape or size. The culture medium 322 may be either a liquid medium or a solid medium. The cells 324 to be measured are, for example, cultured cells, and may be adhesive cells or floating cells. Alternatively, the cells 324 may be spheroids or tissues. In addition, the cells 324 may be derived from any living thing or may be germs or the like. As described above, the sample 300 includes a living sample which is either the living thing itself or is derived from the living thing. The reflecting plate 360 reflects illumination light incident on the sample 300 through the transparent plate 102 to illuminate the cells 324, and is arranged on top of the vessel 310.

The transparent plate 102 arranged on top of the casing 101 of the observation device 100 is made of glass, for example. The sample 300 is statically placed on this transparent plate 102. Although FIG. 1 shows that the top plate of the casing 101 is entirely transparent, the observation device 100 may be designed so that part of the top plate of the casing 101 is a transparent plate, and the remaining part of the top plate is an opaque.

The position where the sample 300 is placed on the transparent plate 102 maybe predetermined, and the transparent plate 102 may be provided with a mark. The position where the sample 300 is placed may be predetermined, and the transparent plate 102 maybe overlaid with a fixing frame on the transparent plate 102 to fix the sample 300.

The image acquiring unit 150 provided inside the casing 101 includes an imaging unit 151, an illumination unit 155, and a supporting unit 165. As shown in FIG. 9, the illumination unit 155 is provided in the supporting unit 165. The imaging unit 151 is provided in the neighborhood of the illumination unit 155 of the supporting unit 165.

As shown in FIG. 10, the illumination unit 155 includes an illumination optical system 156 and a light source 157. The illumination light emitted from the light source 157 is made to travel to the sample 300 by the illumination optical system 156. The light source 157 includes, for example, an LED. The imaging unit 151 includes an imaging optical system 152 and an imaging element 153. The imaging unit 151 generates image data based on an image which is formed on the imaging plane of the imaging element 153 by the imaging optical system 152. The imaging optical system 152 is preferably a zoom optical system capable of changing its focal distance. The imaging unit 151 takes an image of the region where the sample 300 is present, i.e., the Z-axis direction, and thus acquires an image of the sample 300.

The observation device 100 includes a moving mechanism 160. The moving mechanism 160 is provided with an X feed screw 161 and an X actuator 162 for moving the supporting unit 165 in the X-axis direction. The moving mechanism 160 is also provided with a Y feed screw 163 and a Y actuator 164 for moving the supporting unit 165 in the Y-axis direction.

The imaging position in the Z-axis direction is changed by changing the in-focus position of the imaging optical system 152 of the imaging unit 151. In other words, the imaging optical system 152 is provided with a focus adjustment mechanism for, for example, moving a focusing lens in the optical direction. In place of the focus adjustment mechanism or in combination therewith, the moving mechanism 160 may be provided with a Z feed screw and a Z actuator for moving the supporting unit 165 in the Z-axis direction.

The observation device 100 repeatedly takes images using the imaging unit 151, while changing the position of the imaging acquiring unit 150 in the X direction and Y direction using the moving mechanism 160, and a plurality of images corresponding to different positions are acquired thereby. The observation device 100 may synthesize these images to generate a single image showing a wide range.

Furthermore, the observation device 100 may change the imaging position in the Z axis direction, and repeatedly take images, while changing its position in the X direction and the Y direction and synthesize them to thereby sequentially obtain images in the Z direction. An image at each three-dimensional position may be acquired in this manner.

The casing 101 includes a sensor unit 26. The sensor unit 26 has a structure shown in FIG. 2, for example. In the casing 101, pressure measurement is not necessarily required. Thus, the sensor unit 26 is required to comprise at least the temperature sensor 26a, and does not have to include the pressure sensor 26b.

The observation device 100 includes a circuit group 104. The circuit group 104 includes an observation side control circuit 110, an image processing circuit 120, an observation side record circuit 130, an observation side communication device 140, and a clock unit 172.

The observation side record circuit 130 stores, for example, programs and various control parameters used by each of the elements of the observation device 100, movement patterns of the image acquiring unit 150, and the like. The observation side record circuit 130 also stores data and the like obtained by the observation device 100. The data includes an image file, etc.

The image processing circuit 120 performs various kinds of image processing for the image data obtained by the imaging unit 151. After the image processing by the image processing circuit 120, data is, for example, recorded in the observation side record circuit 130 or is transmitted to the controller 200. The image processing circuit 120 may perform various kinds of analysis, based on the obtained image. For example, the image processing circuit 120 may extract an image of the cell or cell group included in the sample 300, or count the number of cells or cell groups, based on the obtained image. The results of this analysis are, for example, recorded in the observation side record circuit 130 or transmitted to the controller 200.

The observation side communication device 140 is a device that communicates with the controller 200. The communications are wireless communications using, for example, Wi-Fi (trademark) or Bluetooth (trademark). The observation device 100 and the controller 200 maybe connected by a cable to perform wired communications between them, and may be connected to an electronic communication line such as the Internet to perform communication by way of an electronic communication line such as the Internet.

The observation side control circuit 110 controls each of the elements of the observation device 100. The observation side control circuit 110 functions as a position controller 111, an imaging controller 112, an illumination controller 113, a communication controller 114, a recording controller 115, and a measurement controller 116. The position controller 111 controls the moving mechanism 160 to control the position of the image acquiring unit 150. The imaging controller 112 controls the imaging operation performed by the imaging unit 151. The illumination controller 113 controls the illumination unit 155. The communication controller 114 controls the communications with the controller 200 performed using the observation side communication device 140. The recording controller 115 controls the recording of data obtained by the observation device 100. The record controller 115 performs control, for example, when the image file is recorded in the observation side record circuit 130. The observation side control circuit 110 has functions as an environmental temperature estimation unit, and estimates an outside temperature of the environmental temperature outside of the observation device 100 based on the output of the temperature sensor 26a of the sensor unit 26 and the operation mode of the observation device 100.

The clock unit 172 generates and outputs time information to the observation side control circuit 110. The observation side control circuit 110 obtains log data in which the time information is associated with the temperature and the pressure measured by the sensor unit 26.

The observation device 100 further includes a power source 190. The power source 190 supplies power to each of the elements included in the observation device 100.

The controller 200 is, for example, a personal computer (PC) or an information terminal such as a tablet type terminal. In FIG. 9, a tablet type information terminal is depicted.

The controller 200 is provided with an input/output apparatus 270 including a display device 272 (e.g., a liquid crystal display) and an input device 274 (e.g., a touch panel). The input device 274 is not limited to the touch panel, but may include a switch, a dial, a keyboard, a mouse, etc.

A controller side communication device 240 is provided for the controller 200. The controller side communication device 240 is, for example, a device that communicates with the observation side communication device 140. The observation device 100 and the controller 200 communicate with each other through the observation side communication device 140 and the controller side communication device 240.

The controller 200 includes a controller side control circuit 210 and a controller side record circuit 230. The controller side control circuit 210 controls each of the elements of the controller 200. The controller side record circuit 230 stores, for example, programs and various parameters used by the controller side control circuit 210. The controller side record circuit 230 also stores data obtained by the observation device 100 and received from the observation device 100.

The controller side control circuit 210 is made of a CPU, an ASIC, and the like, and functions as a system controller 211, a display controller 212, a recording controller 213 and a communication controller 214. The system control unit 211 performs various operations for controlling the measurement of the sample 300. The display control unit 212 controls the display device 272. The recording controller 213 controls the operation of recording information in the controller side record circuit 230. The communication controller 214 controls the communications with the observation device 100 performed using the controller side communication device 240. Also, the controller side control circuit 210 may perform various kinds of analysis, based on the image obtained from the observation device 100. For example, the controller side control circuit 210 may extract an image of the cell or cell group included in the sample 300, or may count the number of cells or cell groups, based on the obtained image.

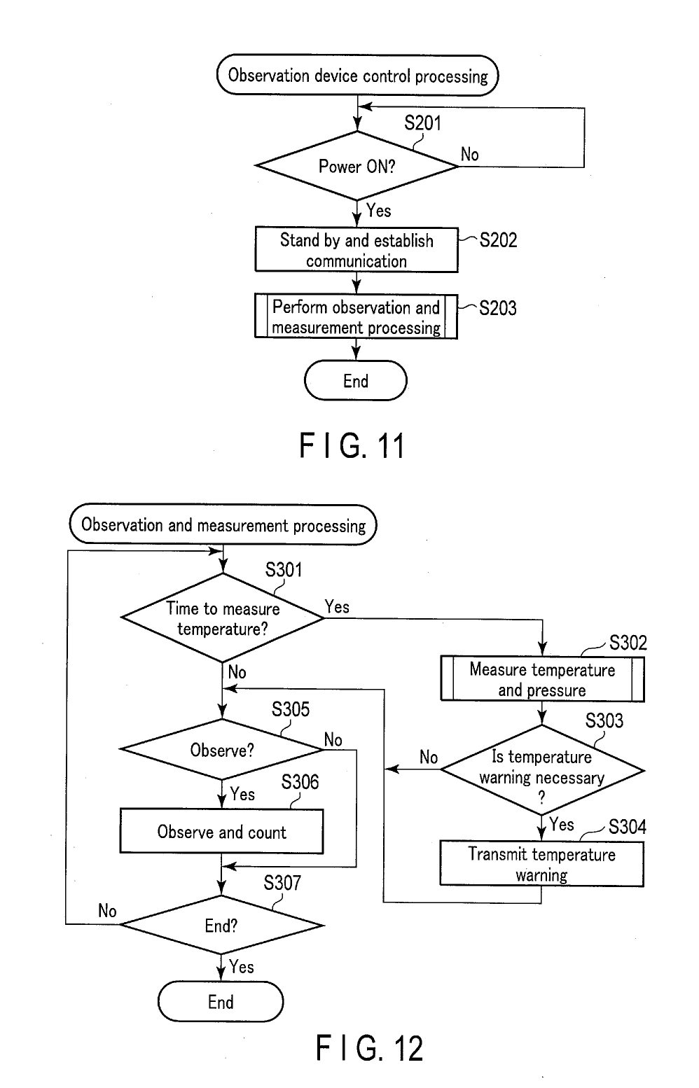

Next, the operations of the observation system 1a will be described. FIG. 11 is a flowchart illustrating observation device control processing that is an operation of the observation device 100. In step S201, the observation side control circuit 110 determines whether the observation device 100 is turned on. For example, when the controller 200 issues an instruction for activating the observation device 100, it is determined that the observation device 100 is turned on. Until it is determined in step S201 that the observation device 100 is turned on, the processing stands by. If it is determined in step S201 that the observation device 100 is turned on, the processing advances to step S202.

In step S202, the observation side control circuit 110 waits for a communication request from the controller 200, and establishes communication in response to the communication request from the controller 200. After the communication is established, the processing advances to step S203.

In step S203, the observation side control circuit 110 executes the observation and measurement processing. After the observation and measurement processing is completed, the processing in FIG. 11 is brought to an end. Hereinafter, the observation and measurement processing will be described. FIG. 12 is a flowchart illustrating the observation and measurement processing.

In step S301, the observation side control circuit 110 determines whether a timing to measure the temperature and the pressure has come. For example, every time a predetermined interval (5 minutes) elapses, it is determined that the timing to measure the temperature and the pressure has come. If it is determined in step S301 that the timing to measure the temperature and the pressure has come, the processing advances to step S302. If it is determined in step S301 that the timing to measure the temperature and the pressure has not come, the processing advances to step S305.

In step S302, the observation side control circuit 110 executes temperature and pressure measurement processing. After the temperature and pressure measurement processing is completed, the processing advances to step S303. The temperature and pressure measurement processing is performed basically in a similar manner to that shown in FIG. 4. When the observation device 100 does not include the GPS unit 22 or the azimuth sensor 24, steps S107 and S108 are omitted. When the sensor unit 26 does not include the pressure sensor 26b, step S105 is omitted as well. In the temperature and pressure measurement processing, in accordance with the operation mode shown in FIG. 7, coefficients a, b, and c (temperature correction formula) are set to correct the temperature sensor output to generate outside temperature data. The observation processing of the observation device 100 includes processing of performing imaging by the imaging unit 151 at the position designated by the user, and processing of repeatedly performing imaging by the imaging unit 151 while moving the position of the image acquiring unit 150 in a predetermined movement pattern. For example, correction coefficients a, b, and c corresponding to the processing of repeatedly performing imaging (e.g., taking a still image) by the imaging unit 151 while moving the position of the image acquiring unit 150 in a predetermined movement pattern may be measured in advance and stored in the setting examples (table) of FIG. 7. When the above-described processing is performed, the above-described correction coefficients (temperature correction formula) are used to generate outside temperature data. In this manner, it is possible to correct the temperature increment inside the observation device including the movement of the imaging unit 151 in addition to the imaging operation mode.

In step S303, the observation side control circuit 110 determines whether temperature warning is necessary. That is, when the outside temperature changes by a value equal to or more than a predetermined value, it is determined that the temperature warning is necessary. The temperature is kept constant in the incubator, but the outside temperature of the observation device 100 may increase by heat generated by the imaging element 153, etc. inside the observation device 100. In particular, when the incubator is provided with multiple observation devices, heat generated by the multiple observation devices may increase the temperature in the incubator. Since the sample 300 maybe affected by the temperature change inside the incubator, when the outside temperature changes by a value equal to or more than a predetermined value, it is determined that the temperature warning is necessary. If it is determined in step S303 that the temperature warning is necessary, the processing advances to step S304. If it is determined in step S303 that the temperature warning is not necessary, the processing advances to step S305.

In step S304, the observation side control circuit 110 transmits to the controller 200 temperature warning information indicating that the temperature warning is necessary. Subsequently, the processing advances to step S305. In response to the temperature warning information from the observation device 100, the temperature warning is displayed on, for example, the display device 272 of the controller 200 to indicate that the outside temperature of the observation device 100 changes by a value equal to or more than the predetermined value. Looking at this temperature warning, a user takes necessary measures such as turning off the observation device 100.

In step S305, the observation side control circuit 110 determines whether an instruction to execute observation processing is received from the controller 200. If it is determined in step S305 that the instruction to execute observation processing is received from the controller 200, the processing advances to step S306. If it is determined in step S305 that the instruction to execute observation processing is not received from the controller 200, the processing advances to step S307.

In step S306, the observation side control circuit 110 executes the observation processing. The observation side control circuit 110 counts cells from the image data obtained by imaging by the imaging unit 151 as needed. The observation processing includes processing of performing imaging by the imaging unit 151 at the position designated by the user, and processing of repeatedly performing imaging by the imaging unit 151 while moving the position of the image acquiring unit 150 in a predetermined movement pattern. After imaging and counting are carried out as described above, the processing advances to step S307. The observation side control circuit 110 may store image data obtained by imaging by the imaging unit 151 in the observation side record circuit 130. At that time, the observation side control circuit 110 may create a file corresponding to each image data obtained and may record in the file the outside temperature data and the pressure data obtained in step S302 in associate with the acquisition time thereof.

The observation side control circuit 110 may record in the file the outside temperature data and the pressure data stored in the observation side record circuit 130 in the temperature and pressure measurement processing. The observation side control circuit 110 may record data of the temperature warning generated in step S304 in association with the generation time. The file created in the above-described manner may be transmitted to the controller side communication device 240 of the controller 200 from the observation side communication device 140.

In step S307, the observation side control circuit 110 determines whether to end the operation of the observation device 100. For example, when operation end instructions such as an instruction to turn off the observation device 100 and an instruction to end the observation and measurement processing are issued by the controller 200, it is determined that the operation of the observation device 100 is ended. If it is determined in step S307 that the operation of the observation device 100 is not ended, the processing returns to step S301. If it is determined in step S307 that the operation of the observation device 100 is ended, the processing in FIG. 12 is brought to an end. Although the temperature and pressure measurement processing is not carried out when the device is powered off, the temperature and pressure measurement processing may be carried out at a predetermined time interval even when the device is powered off.

The embodiment as described above achieves a temperature sensor suitable for the observation device 100 that is often used in the conditions of high ambient temperature and humidity.

The technique of the aforementioned embodiment is applicable to various electronic devices accompanying measurement of the outside temperature, which particularly requires waterproof properties. For example, the technique of the present embodiment can be used as a temperature sensor for measuring an internal body temperature in an endoscope device.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An imaging device including a plurality of operation modes, the imaging device comprising:
a temperature sensor that is provided inside of the imaging device; and
an environmental temperature estimation unit that estimates an outside environmental temperature of the imaging device based on an output of the temperature sensor and the operation modes.

2. The imaging device according to claim 1, wherein the environmental temperature estimation unit selects a calculation formula for calculating the outside environmental temperature in accordance with a current operation mode of the operation modes from a plurality of calculation formulae different in the operation modes, and estimates the outside environmental temperature based on the selected calculation formula and the output of the temperature sensor.

3. The imaging device according to claim 2, wherein the calculation formula is as follows, wherein coefficients a, b, and c in the formula differ in the operation modes:
Te=Ts+a−(b×t^{c})
where Te is the outside environmental temperature, Ts is the output of the temperature sensor, and t is elapsed time from operation start in the current operation mode.

4. The imaging device according to claim 2, further comprising a memory for storing the calculation formula.

5. The imaging device according to claim 1, further comprising:
a time measurement unit that measures time; and
a controller that stores the environmental temperature in association with the measured time.

6. The imaging device according to claim 5, further comprising:
a pressure sensor,
wherein the controller corrects an output of the pressure sensor based on the output of the temperature sensor, and stores the corrected output of the pressure sensor in association with the measured time.

7. The imaging device according to claim 6, wherein the temperature sensor is provided inside of the pressure sensor.

8. The imaging device according to claim 1, wherein the operation modes include a live view display mode, a moving image recording mode, a reproduction mode, and a power off mode.

9. A temperature estimation method of an imaging device including a temperature sensor provided inside and a plurality of operation modes, the method comprising:
obtaining an output of the temperature sensor;
obtaining the operation modes; and
estimating an outside environmental temperature of the imaging device based on the output of the temperature sensor and the operation modes.

10. The temperature estimation method according to claim 9, wherein estimating the environmental temperature comprises:
selecting a calculation formula for calculating the outside environmental temperature in accordance with a current operation mode of the operation modes from a plurality of calculation formulae different in the operations modes; and
estimating the outside environmental temperature based on the selected calculation formula and the output of the temperature sensor.

11. The temperature estimation method of the imaging device according to claim 10, wherein the calculation formula is as follows, wherein coefficients a, b, and c in the formula differ in the operation modes:
Te=Ts+a−(b×t^{c})
where Te is the outside environmental temperature, Ts is the output of the temperature sensor, and t is elapsed time from operation start in the current operation mode.

12. The temperature estimation method of the imaging device according to claim 9, further comprising:
measuring time; and
storing the environmental temperature in association with the measured time.

13. The temperature estimation method of the imaging device according to claim 9, wherein the operation modes include a moving image recording mode and a power off mode.

14. A computer-readable non-transitory storage medium storing a temperature estimation program of an imaging device including a temperature sensor provided inside and a plurality of operation modes, the program comprising:
obtaining an output of the temperature sensor;
obtaining the operation modes; and
estimating an outside environmental temperature of the imaging device based on the output of the temperature sensor and the operation modes.

15. The non-transitory storage medium according to claim 14, wherein estimating the environmental temperature comprises:
selecting a calculation formula for calculating the outside environmental temperature in accordance with a current operation of the operation modes from a plurality of calculation formulae different in the operations modes; and
estimating the outside environmental temperature based on the selected calculation formula and the output of the temperature sensor.

16. The non-transitory storage medium according to claim 15, wherein the calculation formula is as follows, wherein coefficients a, b, and c in the formula differ in the operation modes:
Te=Ts+a−(b×t^{c})
where Te is the outside environmental temperature, Ts is the output of the temperature sensor, and t is elapsed time from operation start in the current operation mode.

17. The non-transitory storage medium according to claim 14, wherein the temperature estimation program further comprises:
measuring time; and
storing the environmental temperature in association with the measured time.

18. The non-transitory storage medium according to claim 14, wherein the operation modes include a moving image recording mode and a power off mode.
